(19) United States
(12) Patent Application Publication
(10) Pub. No.: US 2022/0343233 A1
(43) Pub. Date: Oct. 27, 2022

(54) Systems and Methods for Data Analytics

(71) Applicant: Volantsys Analytics Inc., Rolling Meadows, IL (US)

(72) Inventors: Gowri Selka, Kildeer, IL (US); Srinivas Kolakaluri, Kildeer, IL (US); Balak Binod, Lake Zurich, IL (US); Prajakta Phadke, Bloomington, IN (US); Sharda Bharatula, Barrington, IL (US); Jarabana Aravind, Hyderabad (IN); Keerti Kolakaluri, Kildeer, IL (US)

(73) Assignee: Volantsys Analytics Inc., Rolling Meadows, IL (US)

(21) Appl. No.: 17/728,854

(22) Filed: Apr. 25, 2022

Related U.S. Application Data
(60) Provisional application No. 63/179,052, filed on Apr. 23, 2021.

(51) Int. Cl. G06Q 10/06

(52) U.S. Cl. CPC G06Q 10/0633; G06Q 10/0635

(57) ABSTRACT

A business method and the dBIRD software solution enables success through collaboration and data competency resulting in project-ready blueprints, an input synthesizer, and an embedded conversational chat bot. The project-ready blueprints ensure rigor and standards and result in activating cognitive thinking while enabling collaboration within the business team. The input synthesizer develops business insights, facilitates accountability, and ensures accessibility to model reports. The embedded conversational chatbot engages interdisciplinary teams, results in the transfer of knowledge amongst the team, creates analytics translators, and ensures role-specific coaching. The Chatbot is embedded within the system and provides guidance about methodology, roles, research questions, data science terminology on as-needed basis. The Chatbot also assists to recollect Critical decisions, Features, and Algorithms used in prior solutions developed in the system of the present invention for a quick knowledge transfer between team members and to increase productivity in developing new projects.

### SEQUENCE LISTING OR PROGRAM

Not Applicable

### FEDERALLY SPONSORED RESEARCH

Not Applicable

### TECHNICAL FIELD OF THE INVENTION

The present invention relates to systems and methods for data analysis. More specifically, the present invention is a system and method for data analysis providing documentation of model reports, business requirements, and key decision and insights reports which allow team members to be engaged in the data science development lifecycle through interactive discussions and pre-defined research questions for each phase to ensure the expected business results are met.

### BACKGROUND OF THE INVENTION

According to some industry studies over 85% of data science projects fail and only 4% of companies have succeeded in deploying machine learning (ML) models to production environments. These statistics are alarming to companies that are relying on these initiatives to fuel their digital transformation journey.

Current success factors for Chief Information Officers (CIOs) and data leaders include ensuring that cross functional teams have the skill sets to deliver and prioritize the right projects, continue or stop projects during various phase-gated, iterative, or agile cycles and deploy the right solutions on an individual project basis.

What is needed is a business method and software solution that enables success through collaboration and data competency. The system and methods of data analytics should provide project-ready blueprints, an input synthesizer, and embedded conversational chat bot. The system and method then uses the key feature to create a series of deliverable including a machine learning (ML) software solution, a model risk assessment, organized repository of project artifacts, key decisions and insights reports, data science/AI model reports, and prioritization framework resulting in data-driven culture, attainment of business value, and a future-proof workforce.

### DEFINITIONS

Unless stated to the contrary, for the purposes of the present disclosure, the following terms shall have the following definitions:

Artificial intelligence (AI) is the ability of a computer or a robot controlled by a computer to do tasks that are usually done by humans because they require human intelligence and discernment.

The term “app” is a shortening of the term “application software”. It has become exceedingly popular and in 2010 was listed as “Word of the Year” by the American Dialect Society

“Apps” are regularly available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API”: In computer programming, an application programming interface API is a set of routines, protocols, and tools for building software applications. An API expresses a software module in terms of its operations, inputs, outputs, and underlying types. An API defines functionalities that are independent of their respective implementations, which allows definitions and implementations to vary without compromising each other. A good API makes it easier to develop a program by providing all the building blocks. A programmer then puts the blocks together. In addition to accessing databases or computer hardware, such as hard disk drives or video cards, an API can ease the work of programming GUI modules. For example, an API can facilitate integration of new features into existing applications a so-called “plug-in API”. An API can also assist otherwise distinct applications with sharing data, which can help to integrate and enhance the functionalities of the applications. APIs often come in the form of a library that includes specifications for routines, data structures, object classes, and variables. In other cases, notably SOAP and REST services, an API is simply a specification of remote calls exposed to the API consumers. An API specification can take many forms, including an International Standard, such as POSIX, vendor documentation, such as the Microsoft Windows API, or the libraries of a programming language, e.g., Standard Template Library in C++or Java API.

“API Toolkit”: A toolkit is an assembly of tools; set of basic building units for user interfaces. An “API Toolkit” is therefore a set of basic building units for creating an application programming interface API.

Browser: a software program that runs on a client host and is used to request Pages and other data from server hosts. This data can be downloaded to the client's disk or displayed on the screen by the browser.

Client host: a computer that requests Pages from server hosts, and generally communicates through a browser program.

Content provider: a person responsible for providing the information that makes up a collection of Pages.

Electronic notification: any automated communication received by e-mail, phone, fax, text message, SMS, RSS or any third-party software notification or alerting system.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

Embedded client software programs: software programs that comprise part of a Web site and that get downloaded into, and executed by, the browser.

“GUI”: In computing, a graphical user interface GUI sometimes pronounced “gooey” or “gee-you-eye” is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces CLIs, which require commands to be typed on the keyboard.

Host: a computer that is connected to a network such as the Internet. Every host has a hostname e.g., mypc.mycompany.com and a numeric IP address e.g., 123.104.35.12.

HTML HyperText Markup Language: the language used to author Pages. In its raw form, HTML looks like normal text, interspersed with formatting commands. A browser's primary function is to read and render HTML.

HTTP HyperText Transfer Protocol: protocol used between a browser and a Web server to exchange Pages and other data over the Internet.

HyperText: text annotated with links to other Pages e.g., HTML.

Internet-Based Icon: a graphical or text icon that is linked to this system's database and enables the initiation of contact between the Advisor and the consumer, which is located anywhere throughout the Internet including but not limited to websites, emails, directory listings, and advertisement banners

IP Internet Protocol: the communication protocol governing the Internet.

An Internet service provider ISP is an organization that provides services for accessing, using, or participating in the Internet.

Machine learning is the concept that a computer program can learn and adapt to new data without human intervention. Machine learning is a field of artificial intelligence (AI) that keeps a computer's built-in algorithms current regardless of changes in the worldwide economy.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from wherever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained module.

Server host: a computer on the Internet that hands out Pages through a Web server program.

Natural language processing (NLP) is a subfield of linguistics, computer science, and artificial intelligence concerned with the interactions between computers and human language, in particular how to program computers to process and analyze large amounts of natural language data. The result is a computer capable of “understanding” the contents of documents, including the contextual nuances of the language within them. The technology can then accurately extract information and insights contained in the documents as well as categorize and organize the documents themselves.

A “software application” is a program or group of programs designed for end users. Application software can be divided into two general classes: systems software and applications software. Systems software consists of low-level programs that interact with the computer at a considerably basic level. This includes operating systems, compilers, and utilities for managing computer resources. In contrast, applications software also called end-user programs includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” or smart phone is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smart phones include all of those plus the features of a touchscreen computer, including web browsing, wideband network radio e.g., LTE, Wi-Fi, 3rd-party apps, wireless motion sensor and mobile payment.

A “User” is any person using the computer system executing the method of the present invention.

URL Uniform Resource Locator: the address of a Web module or other data. The URL identifies the protocol used to communicate with the server host, the IP address of the server host, and the location of the requested data on the server host.

A “web application” or “web app” is any application software that runs in a web browser and is created in a browser-supported programming language such as the combination of JavaScript, HTML and CSS and relies on a web browser to render the application.

A “website”, also written as Web site, web site, or simply site, is a collection of related web pages containing images, videos, or other digital assets. A website is hosted on at least one web server, accessible via a network such as the Internet or a private local area network through an Internet address known as a Uniform Resource Locator URL. All publicly accessible websites collectively constitute the World Wide Web.

Web master: the person in charge of keeping a host server and Web server program running.

A “web page”, also written as webpage is a document, typically written in plain text interspersed with formatting instructions of Hypertext Markup Language HTML, XHTML. A web page may incorporate elements from other websites with suitable markup anchors.

Web page: multimedia information on a Web site. A Web page is an HTML document comprising other Web modules, such as images.

The “Web pages” are accessed and transported with the Hypertext Transfer Protocol HTTP, which may optionally employ encryption HTTP Secure, HTTPS to provide security and privacy for the user of the web page content. The user's application, often a web browser displayed on a computer, renders the page content according to its HTML markup instructions onto a display terminal. The pages of a website can usually be accessed from a simple Uniform Resource Locator URL called the homepage. The URLs of the pages organize them into a hierarchy, although hyperlinking between them conveys the reader's perceived site structure and guides the reader's navigation of the site.

Web server: a software program running on a server host, for handing out Pages.

Web site: a collection of Pages residing on one or multiple server hosts and accessible through the same hostname such as, for example, www.topleveldomian.com.

### SUMMARY OF THE INVENTION

The present invention is a business method and software solution that enables success through collaboration and data competency. The number one goal of the present invention is to make it easy for clients to get AI and data science right. The present invention improves AI projects successes while building a data driven culture. The present invention teaches a guided workflow for the cross-functional data science team to analyze data, capture requirements, business insights, define success criteria, document operationalization process, and translate model outputs in business terms.

The system and methods of data analytics taught by the present invention provide project-ready blueprints, an input synthesizer, and an embedded conversational chat bot.

The project-ready blueprints ensure rigor and standards and result in activating cognitive thinking while enabling collaboration within the business team. The input synthesizer develops business insights, facilitates accountability, and ensures accessibility to model reports. The embedded conversational chatbot engages interdisciplinary teams, results in the transfer of knowledge amongst the team, creates analytics translators, and ensures role-specific coaching.

The dBIRD system is the present invention's onboarding service available for clients looking to advance their data science practice and increase adoption within the business and technology teams.

The Chatbot KIT (Knowledge Insights and Templates) embedded within the system of the present invention is to reemphasize the concepts learnt in the Data Coach workshop. The Chatbot KIT provides guidance about methodology, roles, research questions, data science terminology on as-needed basis. The Chatbot also assists to recollect Critical decisions, Features, and Algorithms used in prior solutions developed in the system of the present invention for a quick knowledge transfer between team members and to increase productivity in developing new to projects.

The system of the present invention is built to enable clients to: Define Business Problems; Collect and Analyze Data using Research Questions; Transform data to ensure accurate business outcomes; Collaborate and capture Key Insights and Decisions; Select appropriate business model patterns to develop Machine Learning Solutions; Select Data Science Model Based on Performance Factors; and Translate model recommendations to business decisions.

The system and method of the present invention then uses the key feature to create a series of deliverable including a machine learning (ML) software solution, a model risk assessment/report, a list of business requirements, organized repository of project artifacts, key decisions and insights reports, data science/AI model reports, and prioritization framework resulting in data-driven culture, attainment of business value, and a future-proof workforce.

The present invention enabled team members to be engaged in data science development lifecycle through interactive discussions and pre-defined research questions for each phase to ensure the expected business results are met. Additionally, organizations have access to project artifacts from prior data science projects to assist in future use cases.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the system of the present invention which is designed to work under a set of guided workflows that is broken down into four phases.

FIG. 2 is an outline of the flow of the present invention.

FIG. 3 is an illustrated screenshot of the Dashboard page taught by the present invention.

FIG. 4 is an illustrated screenshot of the Case Detail page taught by the present invention.

FIG. 5 is an illustrated screenshot of the Phase Overview page taught by the present invention.

FIG. 6 is an illustrated screenshot of the Guided Workflow page taught by the present invention.

FIG. 7 is an illustrated screenshot of the Business Requirements page taught by the present invention.

FIG. 8 is an illustrated screenshot of the Business Insights Whiteboard page taught by the present invention.

FIG. 9 is an illustrated screenshot of the Risk Analysis page taught by the present invention.

FIG. 10 is an illustrated screenshot of the Model Performance page taught by the present invention.

FIG. 11 is an illustrated screenshot of the Model Report page taught by the present invention.

FIG. 12 is an illustrated screenshot of the Business Requirements Report page taught by the present invention.

FIG. 13 illustrates an onboarding workshop case study as executed by the system and method of the present invention.

FIGS. 14-19 are a series of flow charts which illustrate the Overall Product Flow of the present invention.

FIG. 20 is a flow chart illustrating the machine learning (ML) development operational process integration workflow.

FIG. 21 is a flow chart illustrating the data literacy personalized and measurable coaching platform.

FIG. 22 illustrates the model risk management dBIRD enhancement.

### DETAILED DESCRIPTION OF THE INVENTION

The following description is demonstrative in nature and is not intended to limit the scope of the invention or its application of uses. There are several significant design features and improvements incorporated within the invention.

Now referring to the Figures, the present invention dBIRD is a system and method for data analysis providing documentation of model reports, business requirements, and key decision and insights reports which allow team members to be engaged in the data science development lifecycle through interactive discussions and pre-defined research questions for each phase to ensure the expected business results are met.

The software platform and system taught by the present for enabling the method of the present invention is designed in two modes: a learning mode and a custom mode.

The Learning Mode is specific to the CMS use case. In the CMS use case, the Learners go through the workflow and answer questions pertaining to the CMS use case.

The Working Mode taught by the present invention is tailored to the organization's specific business case. The questions at the technique level are different in the Custom Mode than it is in the Learning Mode. The working mode will provide interpretation and questions with a focus more on collaboration.

The method of the present invention teaches collaboration and project management workflows with guided questions so the non-data scientists can participate thru the framework. The questions are helpful to promote cognitive thinking like a pre-defined checklist so the non-data scientists don't need to understand the complex data science methods while they can participate to share their domain knowledge to ensure right data science solutions are built. Also, by engaging in the details they understand the data, analysis details, key decisions, business insights which helps the non-data scientists to take accountability while implementing the recommendations provided by the AI models.

The embedded data coach chatbot is conversation based. This allows team members to learn new techniques, learn more about data science terms, processes, coding techniques, how to interpret data analysis reports and when to use what solutions. This enables team members to learn as they work, which is how adults learn. This reduces the cost to train people in new technologies.

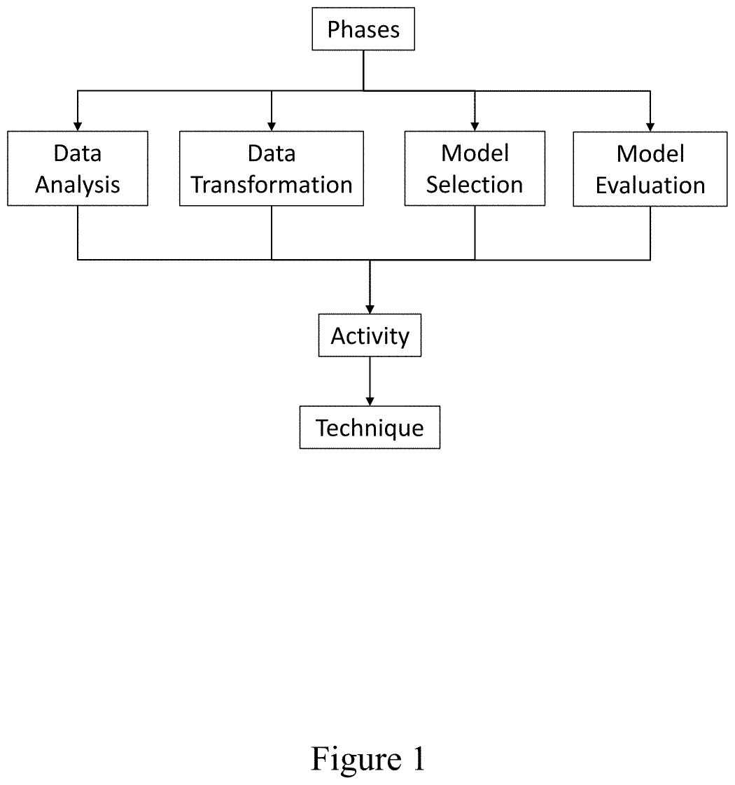

Now referring to FIG. 1, the system of the present invention is designed to work under a set of guided workflows that is broken down into four phases: Data Analysis, Data Transformation, Model Selection, and Model Evaluation. The guided workflows are driven by set of questions and they are defined for a use case based on the type of business problem solved such as a prediction or forecasting problem or a natural language processor need. The answers to the questions are stored in an analytics database that are used for NLP analysis to improve the intelligence in the platform, promote knowledge sharing between team members and reducing future development cycle time of similar solutions. The questions are rendered for all phases in a pre-defined manner, with an option to configure based on types of industries and organization needs.

Users have ability to add their own questions as well, then both the answers and questions must be captured. The questions are categorized as: Phase, Activity, and Technique.

Phase is the highest-level bucket in which there are 4 phases (Data Analysis, Data Transformation, Model Selection, and Model Evaluation). Each Phase is made up of several different activities each trying to solve a part of the problem. Each Activity is made up of several different techniques. This is the lowest level bucket of questions based on the data. There is integration with API from a notebook to pull the outputs of the techniques into the platform for the learner to view through a template.

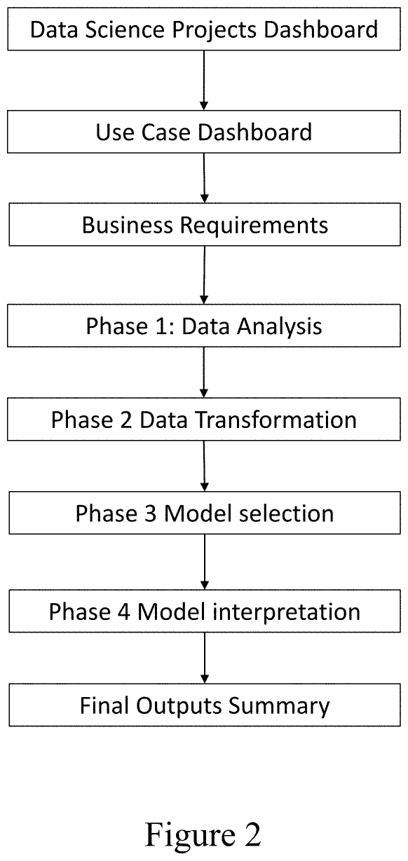

Now referring to FIG. 2, an outline of the flow of the present invention is shown. A Projects Dashboard leads to a Use Case Dashboard. Business Requirements are entered and then a series of analysis phases is undertaken. Phase 1 is the Data Analysis, Phase 2 is the Data Transformation, Phase 3 is Model selection, and Phase 4 is Model interpretation. The outputs are synthesized as the inputs are provided by users and after the phases are completed, a final outputs summary is created for client review.

The platform of the present invention teaches several methods for collaboration throughout its screens. From the Company Data Science Projects Dashboard Screen, the present invention enables Business Analysis, Project Managers, and Data Science team members to see all the open and completed data science projects for the company. This is considered the home page of the platform. Each project has a status to show whether it is Open, Completed, or Cancelled and the outcomes of the completed projects. This will provide a full organization view of projects for tracking purposes.

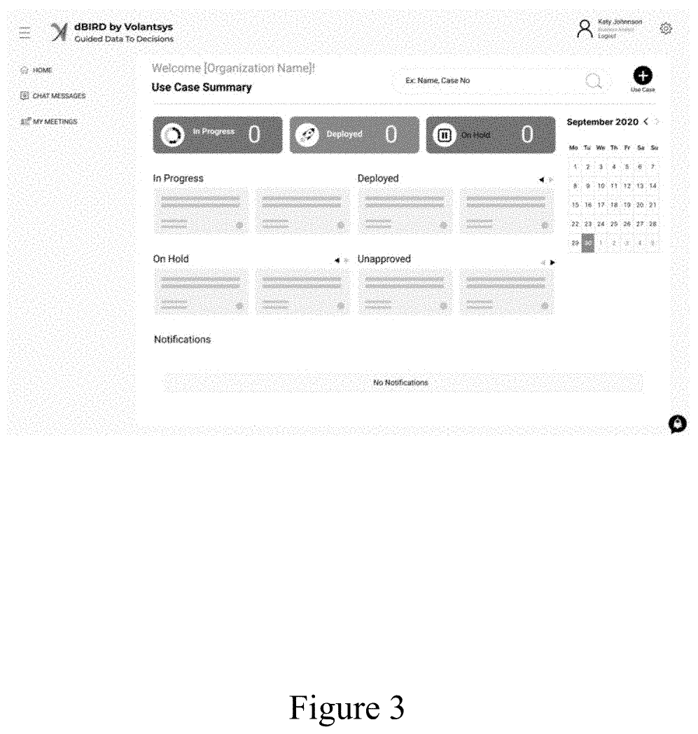

Now referring to FIG. 3, the Dashboard Page is where users would get to see all their use case summaries and its'status. This means they can see what use cases are in progress, deployed, on hold, and/or not yet have been approved. This is also a page to see instant notifications team members have made from a collective of use cases. Ability to send notifications to other collaboration channels like Teams/Slack. The status of the project will be sent through integration methods to JIRA or other project management solutions.

The Dashboard will have a feature for prioritizing all projects based on Business case (Benefits/success measures) and the ability to deliver measured by clarity in scope and risk. The results are shown in four quadrants (Winners, Losers, Try Me, Filler) based on the 2×2 score. Each usecase tile will also show the total prioritization score assigned by the users to help users learn about the health of the project quickly and make timely decisions to avoid cost overrun and cancel weak projects on time.

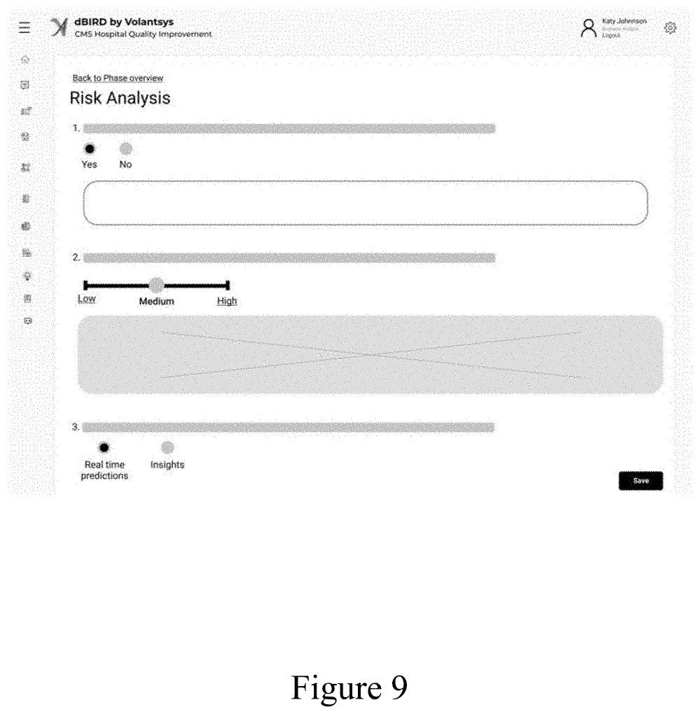

FIG. 9 illustrates a Risk Analysis Page which captures the impact on organization finance, credibility, and people aspect. This will help data scientists to develop right solution as there are many options to create solutions. The risk information is included in requirements report. This page will also capture data governance information. If any classified data is used in the model so an automated notification are sent to privacy officer. This will enable the cross-functional team in large organizations between business owners, compliance team, data analysts, technology teams to assess risk and develop responsible solutions based on the risk to business and the customers.

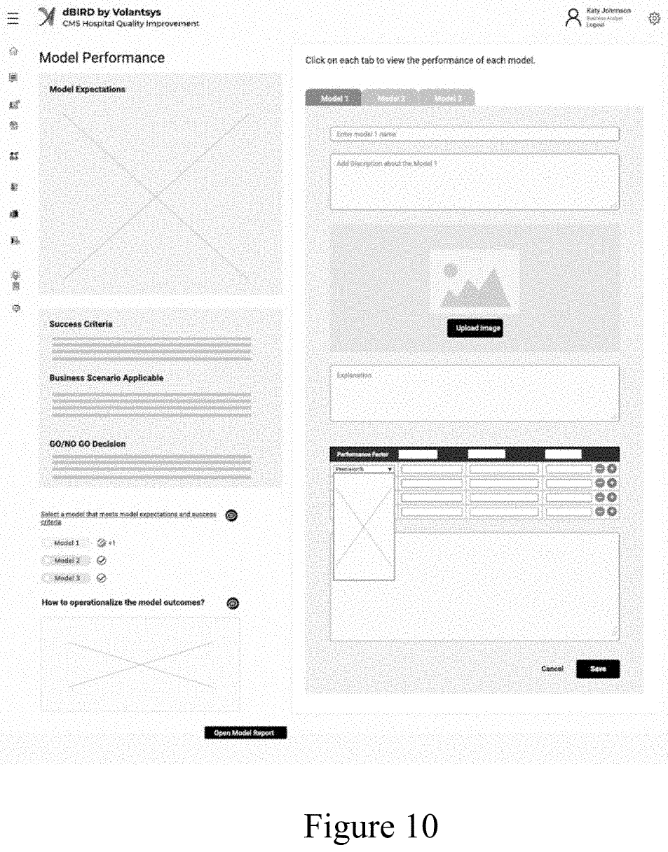

FIG. 10 illustrates a Model Performance Page which shows both requirements on one side and model performance factors on right side. The users can compare both to select the right model. Additionally, the embedded KIT™ chatbot will provide knowledge to understand performance measures to enable non data scientists to understand and apply their knowledge to develop right data science solutions by bridging the gap between business and data science teams.

Additionally, the Dashboard has the ability to start and stop the project based on progress and score given by the team.

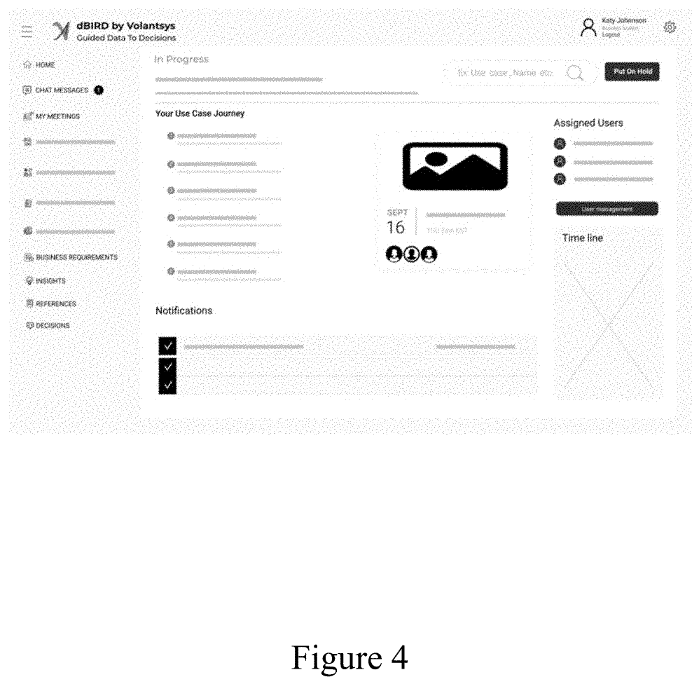

FIG. 4 illustrates the use Case Detail Page which allows users to see the details of a specific use case which includes their use case status, assigned team members, notifications, and team members updates. The timeline to progress from one phase to another is tracked to help teams improve effectiveness and find roadblocks so they can address them on time; stop inefficient project early to avoid cost. They can also place a project ON HOLD and add comments to capture reason for the decision. The solution enables continued flow of information as the development and business team change over time, so the knowledge, decisions, rationale are not lost over time and accessible to everyone across the organization to operate the data science competency in an efficient manner.

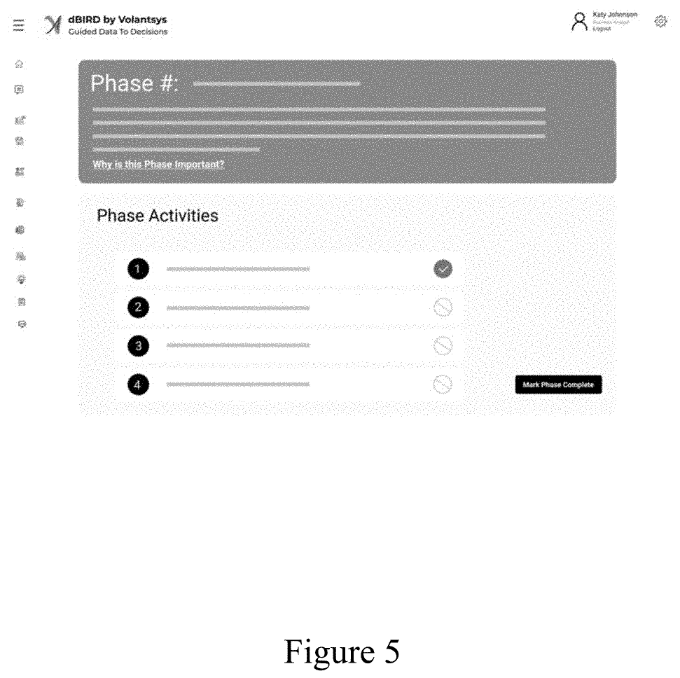

FIG. 5 illustrates the Phase Overview Page which allows users to navigate to their phase activities by Data science model type and they are configurable. The workflow is streamlined, team cannot move to next activity unless complete the prior one. The intent is to avoid unnecessary effort as the data may not be available to proceed and also to ensure the team develops the solution in a right way.

From a Business Requirements and Insights Screen each answer that the learner provides to the Business Requirements and Insights questions should reference a template PDF. Answers to questions in the Business Requirements and Insights for each phase are put into a database with other learner's answers along with the source of the template PDF, individual, and date.

From a Business Insights Whiteboard, where the Business Insights Whiteboard has a drag and drop functionality where the learner can move their answers from the guided workflows screen where they provided business insights through data analysis to business requirements or to either Key Insights or Decisions buckets. The platform would have already categorized all their insights by the different dimensions based on the guided workflow questions. Learners can view answers from other members in their team and reply to them directly. The answers are color-coded per each teammate. The learners have the ability to add additional insights. Project Manager will have the ability to rank the key insights and decisions by order of importance on this screen.

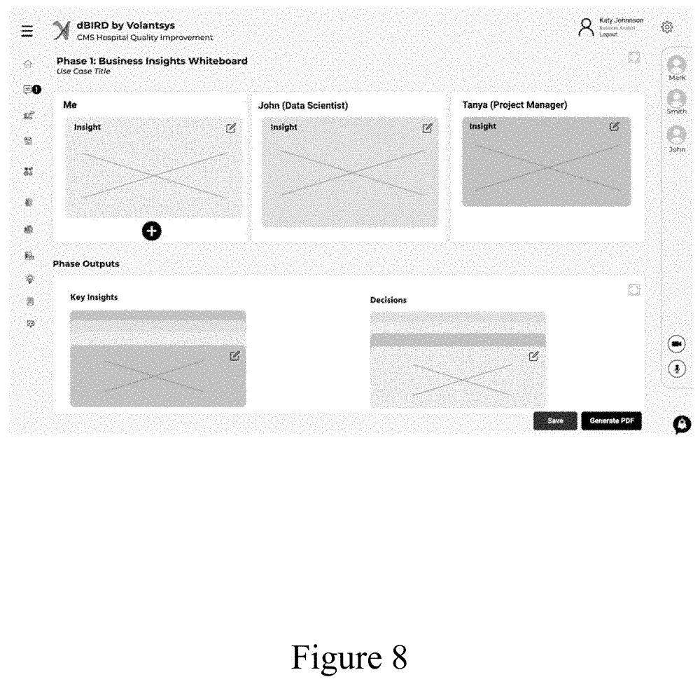

FIG. 8 illustrates the Business Insights Whiteboard Page where teams get to come together and map their desired outputs to the respective categories (Key Insights or Decisions). Key decisions and business insights are collected from all team members which becomes a central source of knowledge gathered based on detailed data analysis and subject matter expertise which are typically lost in the current data science development process.

Similar to the Business Insights Whiteboard, on a Business Requirements Whiteboard learners can drag and drop their requirement answers into the different process steps (Problem Definition, Scope, Success Criteria, Model Expectations). Learners can view answers from other members in their team and reply to them directly. The answers are color-coded per each teammate. The learners have the ability to add additional requirements. Team members can consolidate business requirements from everyone's input into one coherent artifact that serves as a reference for the solution. This artifact evolves as the team performs data analysis and transformation phases to ensure the information from these activities are translated to core business requirements that drives the data science solution development approach.

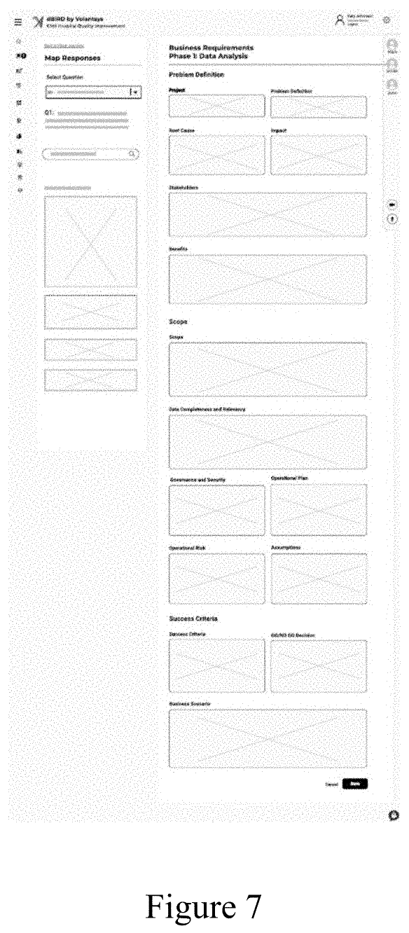

FIG. 7 illustrates the Business Requirements Page which serves like a whiteboard where teams can consolidate their responses and drag and drop them into individual business requirement sections. Allows to create accurate requirements based on all teams' inputs and data analysis. This will allow team to ensure the solution is built to meet the requirements and success criteria. The team has ability to score each section from 1 thru 10, worst to good. The score is used to prioritize all use cases based on business case and ability to deliver. This will help organizations to select right use case for development that maximizes business value.

On All Screens Learners will have a chat option to discuss any questions with the instructor or other teammates or send a message to them.

Once the business requirements document has been completed, the project manager or BA in charge will provide the approval to generate the model. Once the model has been generated and interpreted by the business analysts and operationalization decisions have been made, a final sign-off are received from the stakeholders to ensure that they agree with the next steps.

The system of the present invention can also send email alerts for approval. As the learner continues to answer the Business Requirements and Insights questions, the Insights document and the Business Requirements document will get built based on their answers. The learner picks and chooses which answer becomes an insight or a decision on the Business Insights Whiteboard and which process step (Problem Definition, Scope, Success Criteria, Model Expectations) the requirements fall under in the Business Requirements Whiteboard.

At any point during the platform, the learner can download an Insights PDF document from the Business Insights Whiteboard or Business Requirements PDF document from the Business Requirements Whiteboard.

At the end of all the phases, the learner would the ability to compile all final information into three separate preformatted PDF documents: Insights document, Business Requirements, and Model Report. The system also has the ability to add images to the responses to model report, the comments and images must be stored along with the model report.

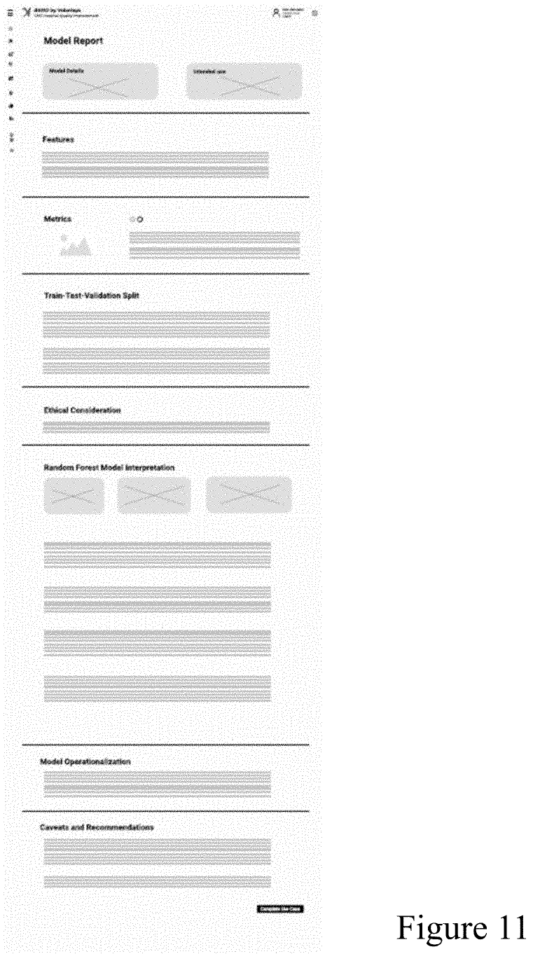

FIG. 11 illustrates a Model Report Page which is the model report layout that can be edited and collaborated on to achieve a customized result that meets the business needs. The model report layout changes based on algorithm type, such as forecasting model, NLP. Supervised and unsupervised models. The model report synthesizes the response for key information provided through the guided workflows for all four phases based on the algorithm type to assemble information which can be edited by the team members. The model report has ability to add attachments, rich text editing so additional information can be added and becomes one repository. Enables knowledge transfer across the organization.

The system will show outputs captured from notebook for each technique/activity. The system provides the ability to integrate with the notebooks in client's platform to pull PDF files and show them in a way that users can scroll back and forth to respond to questions in the guided workflows.

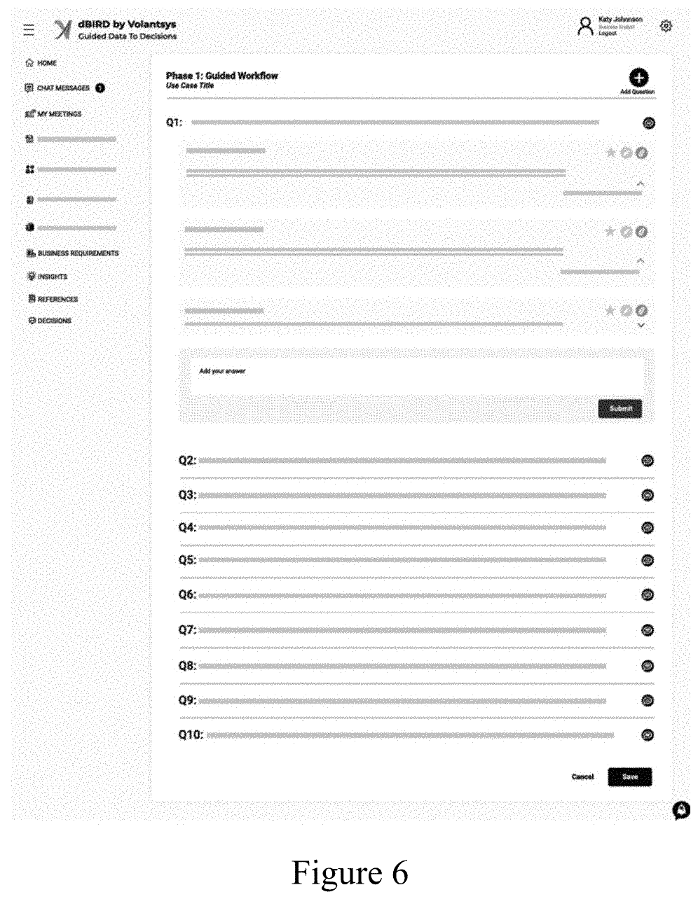

FIG. 6 illustrates a Guided Workflow Page which allows users to work through guided questions to assist them in understanding more about their use case data and how it connects to the business aspect and allows team collaborations to capture inputs from interdisciplinary team. Users have ability to ark their response as key insights and decisions so the system can select them to share with organization. Users have ability to add attachments to share reference materials, and for security purpose the documents are not downloadable.

In the future integrations there are more tightly coupled with machine learning platforms. An administration feature provides the ability to assign files to activity/techniques, the ability to assign approver and add users to use case, and the ability to configure system parameters.

System architecture enables a multi-tenant subscription-based cloud solution on AZURE which provides secured and access restricted by authentication and approvals/roles, uses open source and Azure tech stack, and the ability to integrate with data/data science platform hosted outside of this platform. Refer to the new arch diagram/PPT sent. ML Workflow

The present invention teaches the ability to setup initial use case content—Question, activity, techniques, phase, phase 3,4 questions, reference docs, access control—role setup.

An HTML/PDF file from data sci tool provides integration points (admin page will give option to map this file to activity/tech, they can have one to many mapping); Include comments (what changed in this file given by users). The NLP takes this document and extracts data elements and add the list of data elements to the same HTML doc uploaded. Data elements are mapped to each document; NLP second phase to create template from the outputs; Templates are in PDF type.

Tags for insights include inspection, quality, governance, risk, ethics; Tags for biz re scope, success criteria, model expectations, Questions—change by use case, users, role. Users can add questions and they are tied to misc. techniques within activity.

Answers include versions, use case, user based; can be tied to a set of data elements; can be prioritized by users; and are grouped by data elements—using NLP—to show the affinity groups for whiteboard based on the data elements.

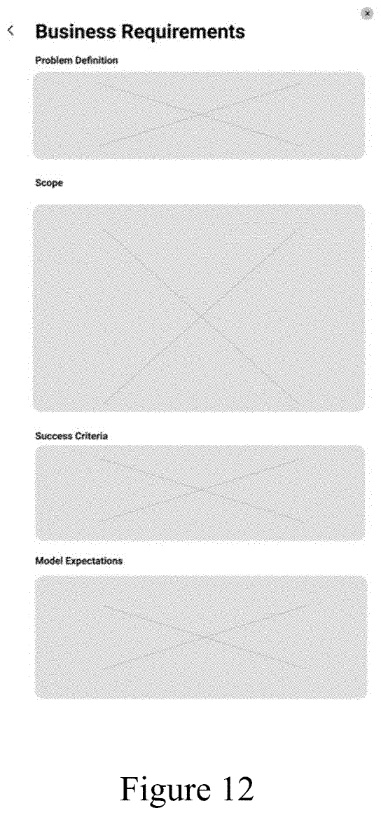

FIG. 12 illustrates the Business Requirements Report Page which is the final layout of the Business Requirements mapping outputs in a pdf format.

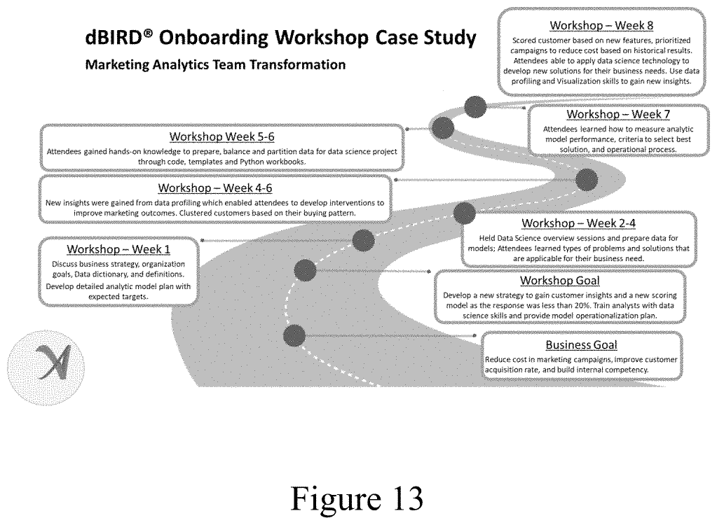

Now referring to FIG. 13 and Onboarding Workshop Case study is present. In first and second steps business and workshop goals are established. Business goals reduce cost in marketing campaigns, improve customer acquisition rate, and build internal competency. Workshop goals develop a new strategy to gain customer insights and a new scoring model as the response was less than 20% and train analysts with data science skills and provide model operationalization plan.

In this example, in a first week the marketing analysis team first discusses business strategy, organization goals, Data dictionary, and definitions while developing a detailed analytic model plan with expected targets. In weeks 2-4, Data Science overview sessions are held to prepare data for models and Attendees learn the types of problems and solutions that are applicable for their business need.

In weeks 4-6 new insights were gained from data profiling which enabled attendees to develop interventions to improve marketing outcomes. Clustered customers based on their buying pattern. In weeks 5-6 attendees gained hands-on knowledge to prepare, balance and partition data for data science project through code, templates, and Python workbooks. In week 7 attendees learned how to measure analytic model performance, criteria to select best solution, and operational process. Finally, in week 8 customer are scored based on new features, campaigns are prioritized to reduce cost based on historical results. Attendees are able to apply data science technology to develop new solutions for their business needs and use data profiling and Visualization skills to gain new insights.

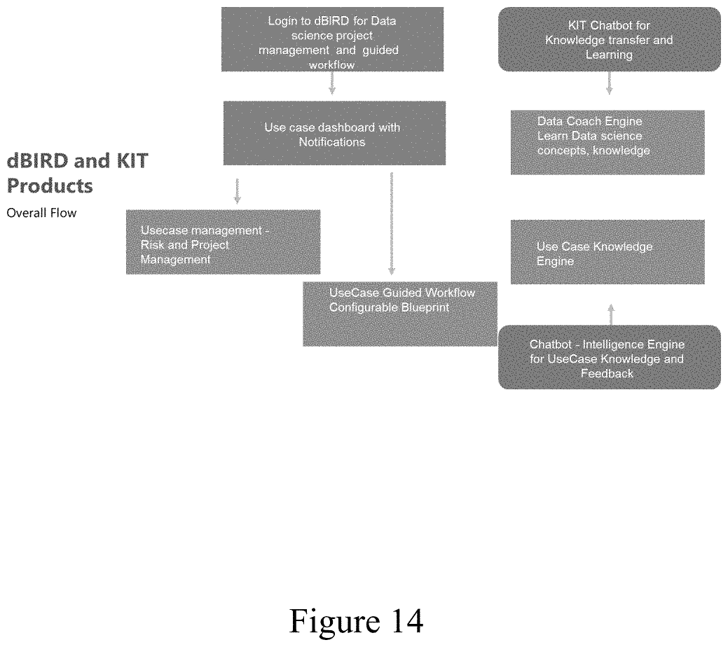

Now referring to FIGS. 14-19, a series of flow charts which illustrate the Overall Product Flow of the present invention are illustrated. FIG. 14 illustrates where a user logs into the system for a data science project management and guided workflow. Next a use case dashboard is displayed with notifications. The chatbot provided for knowledge transfer interacts with a data coach engine to learn data science concepts and knowledge while a use case knowledge engine interacts with a Chatbot for Intelligence Engine for Use Case Knowledge and Feedback.

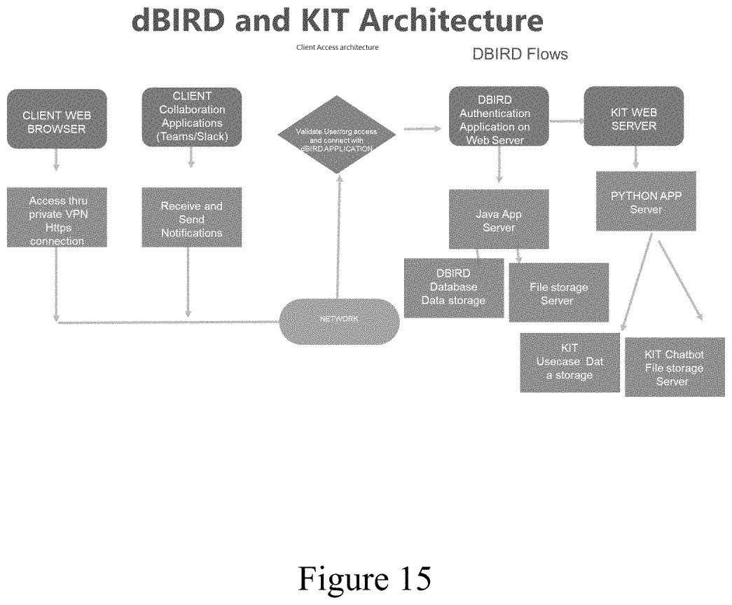

FIG. 15 illustrates the architecture of the present invention where an application enables access by a user and connects to the customer network. The application authenticates a user using an authentication application on a web server, which is connected to a second web server connected to a PYTHON/WEB application server able to access usecase data storage and a chatbot file storage server. The authentication server also connects to a JAVA application server which connects to a database data storage and file storage server. The network also receives input from a client web browser accessing through a private VPN HTTPS connection and a client collaboration applications (Teams/Slack) sending and receiving notifications. The system integrates with JIRA to update project status updates.

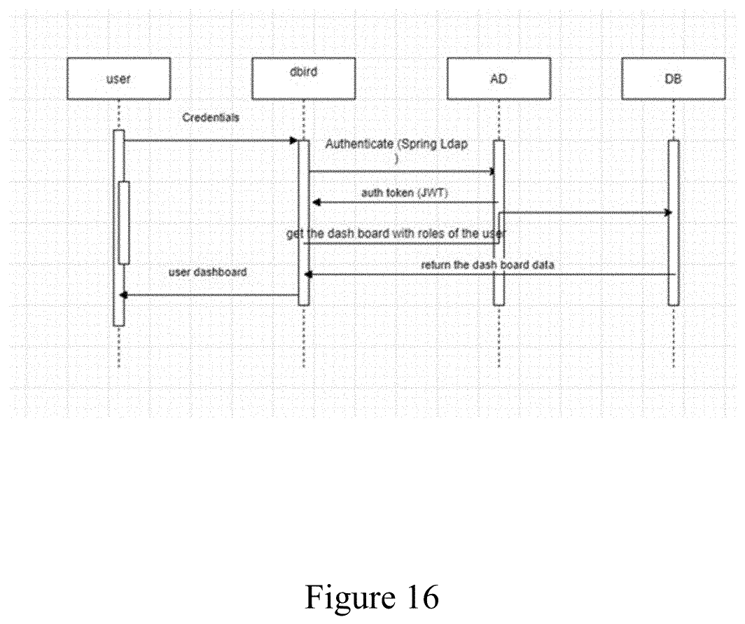

FIG. 16 illustrates the physical structure of the system where a user, the system, and AD (authentication Active Directory), and DB (Database) are connected and can communicate with each other in the processing and sharing information from credential/authentication through dashboard data and display.

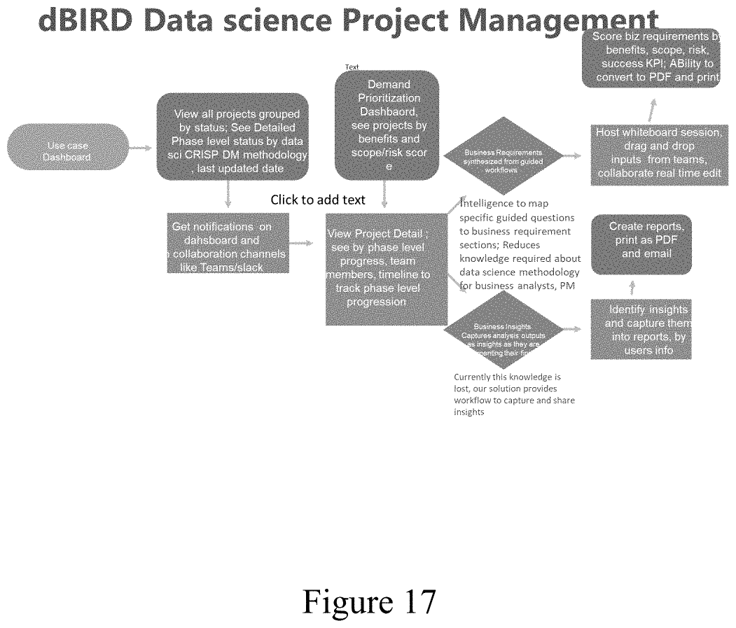

FIG. 17 illustrates the project management workflow of the present invention where a use case dashboard is presented, and a user can view all projects and see detailed phase level status. Notifications are received on the dashboard as well as collaboration channels like JIRA/Teams/Slack. A Demand Prioritization Dashboard enabled a user to see projects by benefits and scope/risk score is presented with a View Project Detail option for a user to see projects by phase level progress, team members, or timeline to track phase level progression. Intelligence to map specific guided questions to business requirement sections and reduces knowledge required about data science methodology for business analysts, PM is used. Business Insights Captures analysis outputs as insights as they are documenting their findings and Business Requirements synthesized from guided workflows are illustrated. Identify insights are identified and captured into reports by user's info to create reports, print as PDF and email. A host whiteboard session enables drag and drop inputs from teams and allows them to collaborate real time and edit. Score biz requirements by benefits, scope, risk, success KPI are combined with the ability to convert to PDF and print.

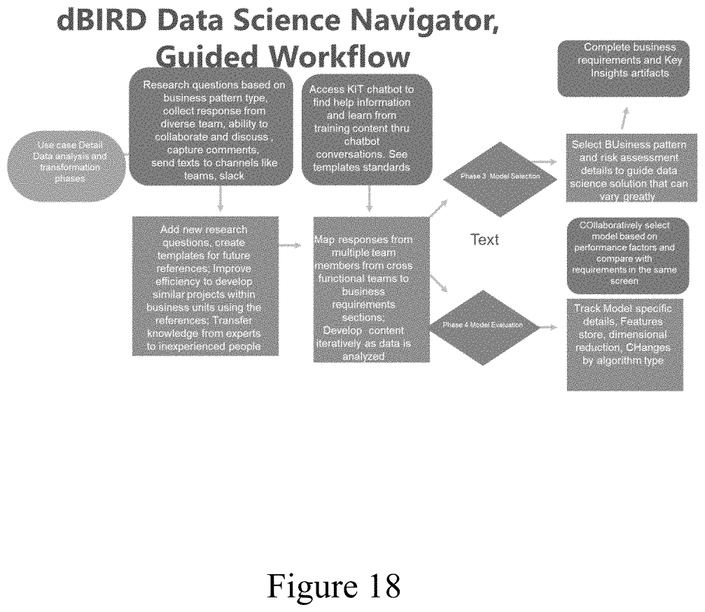

FIG. 18 illustrates the data scient navigator guided workflow. A Use case with Detail Data analysis and transformation phases starts the process. Second, Research questions based on business pattern type, collect response from diverse team, ability to collaborate and discuss, capture comments, send texts to channels like teams, slack. Third Add new research questions, create templates for future references; Improve efficiency to develop similar projects within business units using the references; Transfer knowledge from experts to inexperienced people. In a Fourth step Map responses from multiple team members from cross functional teams to business requirements sections; Develop content iteratively as data is analyzed. Access KIT chatbot to find help information and learn from training content thru chatbot conversations. See templates standards. The system next progresses though phrase 3 model selection to select business pattern and risk assessment details to guide data science solution that can vary greatly and phase 4 model evaluation steps to track Model specific details, Features store, dimensional reduction, and changes by algorithm type.

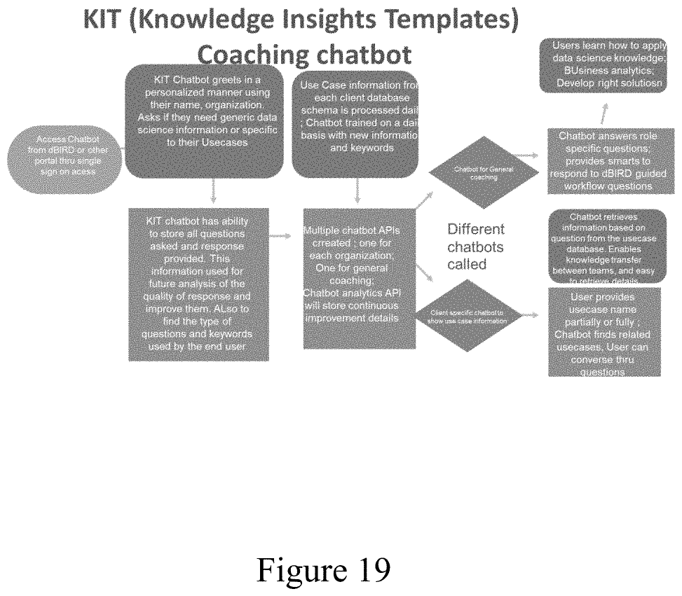

In FIG. 19, the KIT (Knowledge Insights Templates) Coaching chatbot flow is illustrated. The process starts fir with enabling access to the chatbot through the system or other portal. Next the KIT Chatbot greets in a personalized manner using their name, organization. Asks if they need generic data science information or specific to their Usecases. The KIT chatbot has ability to store all questions asked and response provided. This information used for future analysis of the quality of response and improve them and also to find the type of questions and keywords used by the end user. Multiple chatbot APIs are created; one for each organization; One for coaching general data science knowledge and another chatbot to search through data science project details captured as use cases within the solution; Chatbot analytics API will store continuous improvement details. Use Case information from each client database schema is processed daily; the Chatbot is trained on a daily basis with new information and keywords. Next different chatbots are called for general coaching and specific chatbots to show use case information.

General chatbots answer role specific questions; provides smarts to respond to system guided workflow questions and users learn how to apply data science knowledge; business analytics; Develop right solutions.

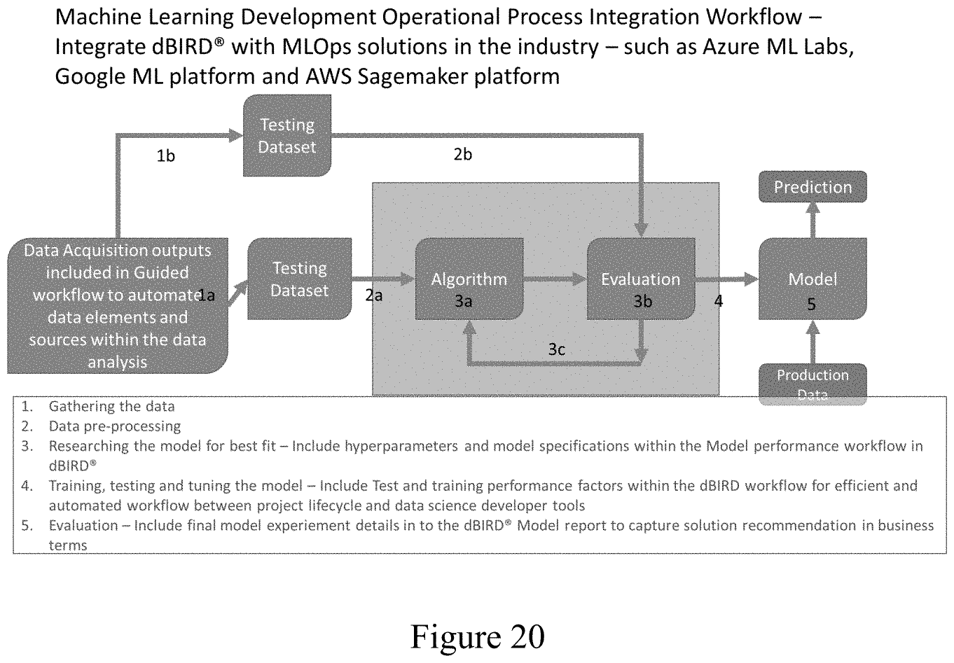

Now referring to FIG. 20 the machine learning (ML) development operational process integration workflow is illustrated where the system taught by the present invention is integrated with machine learning operations (MILOps) solutions such as AZURE ML Labs, GOOGLE ML platform, and AWS SAGEMAKER platform.

In a first step gathering of the data is performed followed by data pre-processing. Data Acquisition outputs included in Guided workflow to automate data elements and sources within the data analysis followed by dataset testing. Next researching the model for best fit, including hyperparameters and model specifications within the model performance workflow is performed by the system using an algorithm. Now training, testing, and tuning of the model occurs, including test and training performance factors within the system's workflow for efficient and automated workflow between project lifecycle and data science developer tools. After testing of the data set or processing by the algorithm, evaluation by the system occurs including final model experiment details into the system model report to capture solution recommendations in business terms creating a prediction or production data.

Specific chatbots to show use case information are selected where a User provides usecase name partially or fully; and the Chatbot finds related usecases, and a User can converse thru questions and the Chatbot retrieves information based on question from the usecase database. Enables knowledge transfer between teams, and easy to retrieve details.

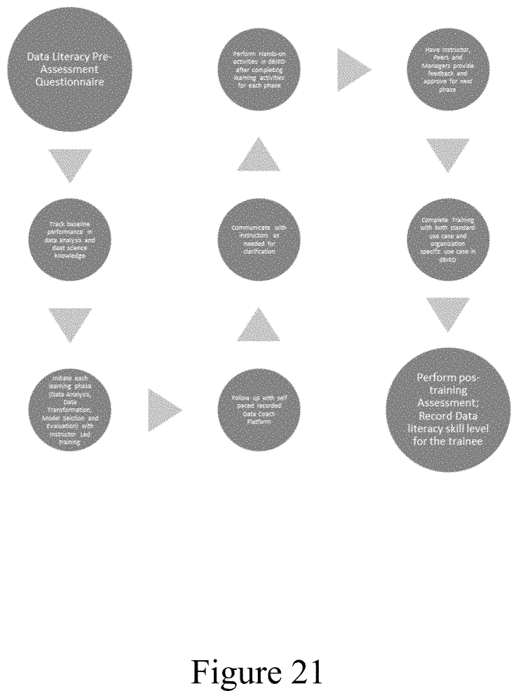

Now referring to FIG. 21 a flow chart illustrating the data literacy personalized and measurable coaching platform is illustrated. Unique features include a Blend of scalable hybrid, self-paced learning platform with customized hands-on learning opportunities that integrates learning process with hands-on work performed with their company data.

The coaching platform teaches the ability to perform post-assessment by their peer, manager, and instructor which provides a comprehensive guidance and motivation to apply learning concepts, which reduces training time and time needed to translate learning and applying within their work.

The post-assessment feature provides the ability to track Data Literacy skill level within the customer's organization.

In a first step, a data literacy pre-assessment questionnaire is presented which tracks baseline performance in data analysis and data science knowledge. The next step is to initiate each learning phase (Data Analysis, Data Transformation, Model Selection, and Evaluation) with instructor led training. This is followed up with the self-paced recorded data coach platform. Then communication with instructors as needed for clarification is provided. Next, the system enables the performance of hands-on activities in dBIRD after completing learning activities for each phase. Instructors, Peers, and Managers provide feedback and approve for the next phase. Next training is completed for both the standard use case and organization specific cases in dBIRD. Finally, the system performs a post-training assessment and records a data literacy skill level for the trainee.

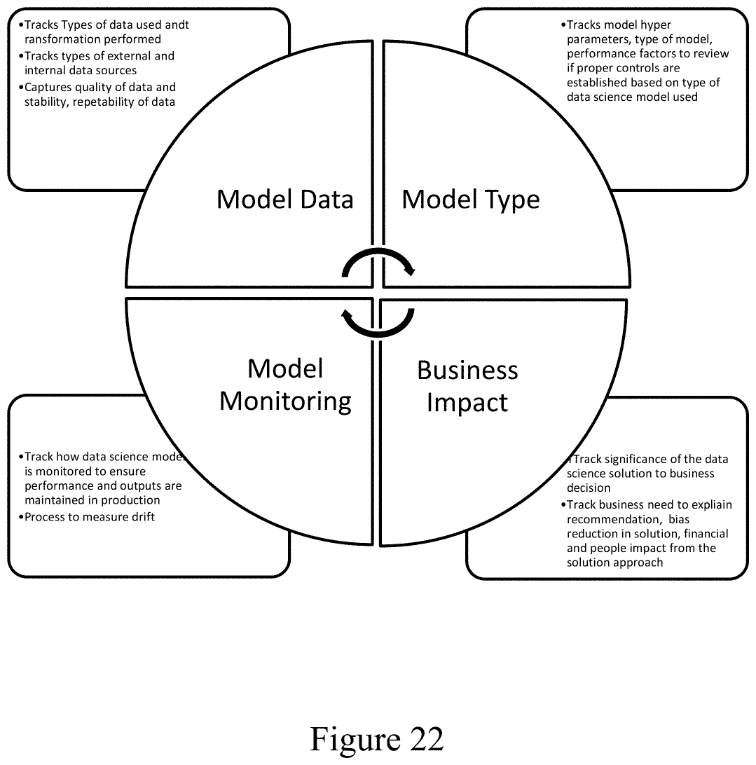

FIG. 22 illustrates the model risk management dBIRD enhancement. Model Risk is part of the phase three Model selection phase in dBIRD. This phase is unique in integrating the model details and company risk exposure level to enable model risk auditors and compliance officers to understand the risk level of the data science enable solution and provide their decision to either approve or stop from deploying the solution to production.

Model data tracks types of data used and transformation performed; tracks types of external and internal data sources, and captures quality of data and stability, repeatability of data. Model type tracks model hyper parameters, type of model, performance factors to review if proper controls are established based on type of data science model used.

Business impact tracks significance of the data science solution to business decision and track business need to explain recommendation, bias reduction in solution, financial, and people impact from the solution approach.

Model monitoring tracks how data science model is monitored to ensure performance and outputs are maintained in production and processes the data to measure drift.

Model data, model type, business impact, and model monitoring can continue in an endless loop for as man iterations as desired b the user.

The method of the present invention is set to run on a computing device. A computing device on which the present invention can run are comprised of a CPU, Hard Disk Drive, Keyboard, Monitor, CPU Main Memory, and a portion of main memory where the system resides and executes. Any general-purpose computer with an appropriate amount of storage space is suitable for this purpose. Computer Devices like this are well known in the art and are not pertinent to the invention. The method of the present invention can also be written in a number of different software languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same are apparent from the above description. Accordingly, no further discussion relating to the manner of usage and operation are provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for data analysis providing documentation of model reports, business requirements, and key decision and insights reports which allow team members to be engaged in the data science development lifecycle through interactive discussions and pre-defined research questions for each phase to ensure the expected business results are met, comprising the steps of:
accessing a machine-executable module encoding a predictive modeling procedure, wherein the predictive modeling procedure includes a plurality of tasks, wherein a plurality of tasks is performed; and executing the machine-executable module, wherein executing the machine-executable module comprises performing the data analysis procedure, including:
a method for data analysis providing documentation of model reports, business requirements, and key decision and insights reports which allow team members to be engaged in the data science development lifecycle through interactive discussions and pre-defined research questions for each phase.

2. The method of claim 1, further comprising of two modes: a learning mode and a custom mode.

3. The method of claim 2,
the Learning Mode is specific to the CMS use case; and
in the CMS use case, the Learners go through the workflow and answer questions pertaining to the CMS use case.

4. The method of claim 2,
the Working Mode is tailored to the organization's specific business case;
the questions at the technique level are different in the Custom Mode than it is in the Learning Mode; and
the working mode will provide interpretation and questions with a focus more on collaboration.

5. The method of claim 1, further comprising
an embedded data coach chatbot which is conversation based.

6. The method of claim 1, further comprising
a set of guided workflows broken down into four phases;
Data Analysis,
Data Transformation,
Model Selection, and
Model Evaluation.

7. The method of claim 6, wherein
the guided workflows are driven by set of questions and they are defined for a use case; and
the questions are rendered for all phases in a pre-defined manner;
Users have ability to add their own questions as well;
then both the answers and questions must be captured; and
the questions are categorized as: Phase, Activity, and Technique.

8. The method of claim 6, wherein
each Phase is made up of several different activities each trying to solve a part of the problem;
each Activity is made up of several different techniques;
this is the lowest level bucket of questions based on the data; and
there is integration with API from a notebook to pull the outputs of the techniques into the platform for the learner to view through a template.

9. The method of claim 1, further comprising
a Projects Dashboard leads to a Use Case Dashboard;
Business Requirements are entered and then a series of analysis phases is undertaken;
after the phases are completed, a final outputs summary is created for client review.

10. The method of claim 1, further comprising
several methods for collaboration throughout its screens;
from the Company Data Science Projects Dashboard Screen, the present invention enables Business Analysis, Project Managers, and Data Science team members to see all the open and completed data science projects for the company; and
each project has a status to show whether it is Open, Completed, or Cancelled and the outcomes of the completed projects.

11. The method of claim 1, further comprising
a Dashboard Page where users would get to see
all their use case summaries and its'status;
what use cases are in progress, deployed, on hold, and/or not yet have been approved;
instant notifications team members have made from a collective of use cases;
the ability to send notifications to other collaboration channels like Teams/Slack;
a feature for prioritizing all projects based on Business case (Benefits/success measures) and the ability to deliver measured by clarity in scope and risk;
the results are shown in four quadrants (winners, Losers, Try Me, Filler) based on the 2×2 score; and
the Dashboard has the ability to start and stop the project based on progress and score given by the team.

12. The method of claim 1, further comprising
a Risk Analysis Page which captures the impact on organization finance, credibility, and people aspect;
risk information is included in requirements report; and
this page will also capture data governance information.

13. The method of claim 1, further comprising
a Model Performance Page which shows both requirements on one side and model performance factors on right side where the users can compare both to select the right model.

14. The method of claim 1, further comprising
a Case Detail Page which allows users to see the details of a specific use case which includes their use case status, assigned team members, notifications, and team members updates; and
the timeline to progress from one phase to another is tracked to help teams improve effectiveness and find roadblocks so they can address them on time; stop inefficient project early to avoid cost.

15. The method of claim 1, further comprising
a Phase Overview Page which allows users to navigate to their phase activities by Data science model type and they are configurable;
the workflow is streamlined, team cannot move to next activity unless complete the prior one.

16. The method of claim 1, wherein
from a Business Requirements and Insights Screen each answer that the learner provides to the Business Requirements and Insights questions should reference a template PDF; and
answers to questions in the Business Requirements and Insights for each phase are put into a database with other's learner's answers along with the source of the template PDF, individual, and date.

17. The method of claim 1, wherein
from a Business Insights Whiteboard, where the Business Insights Whiteboard has a drag and drop functionality where the learner can move their answers from the Business Requirements and Insights screen to either Key Insights or Decisions buckets;
the platform categorizes all their insights by the different dimensions;
learners can view answers from other members in their team and reply to them directly;
the answers are color-coded per each teammate;
the learners have the ability to add additional insights; and
a project Manager will have the ability to rank the key insights and decisions by order of importance on this screen.

18. The method of claim 1, wherein
on a Business Requirements Whiteboard learners can drag and drop their requirement answers into the different process steps (Problem Definition, Scope, Success Criteria, Model Expectations);
learners can view answers from other members in their team and reply to them directly;
the answers are color-coded per each teammate; and
the learners have the ability to add additional requirements.

19. The method of claim 1, wherein
a Business Requirements Page serves as a whiteboard where teams can consolidate their responses and drag and drop them into individual business requirement sections;
allows users to create accurate requirements based on all teams' inputs and data analysis;
allows the team to ensure the solution is built to meet the requirements and success criteria;
the team has ability to score each section from 1 thru 10, worst to good;
the score is used to prioritize all use cases based on business case and ability to deliver.

20. The method of claim 1, wherein
once the business requirements document has been completed, the project manager or BA in charge will provide the approval to generate the model; and
once the model has been generated and interpreted by the business analysts and operationalization decisions have been made, a final sign-off are received from the stakeholders to ensure that they agree with the next steps.

21. The method of claim 1, wherein
as the learner continues to answer the Business Requirements and Insights questions, the Insights document and the Business Requirements document will get built based on their answers;
the learner picks and chooses which answer becomes an insight or a decision on the Business Insights Whiteboard and which process step (Problem Definition, Scope, Success Criteria, Model Expectations) the requirements fall under in the Business Requirements Whiteboard; and
at any point during the platform, the learner can download an Insights PDF document from the Business Insights Whiteboard or Business Requirements PDF document from the Business Requirements Whiteboard.

22. The method of claim 1, wherein
at the end of all the phases, the learner would the ability to compile all final information into three separate preformatted PDF documents: Insights document, Business Requirements, and Model Report; and
the system also provides capability to add images to the responses to model report, the comments and images must be stored along with the model report.
